(19) United States
(12) Patent Application Publication
(10) Pub. No.: US 2024/0220764 A1
(43) Pub. Date: Jul. 4, 2024

(54) EFFICIENT ZERO PADDING IN CONVOLUTION AT NEURAL PROCESSOR

(71) Applicant: Apple Inc., Cupertino, CA (US)

(72) Inventors: Sayyed Karen Khatamifard, Bellevue, WA (US); Alon Yaakov, Raanana (IL); Jeffrey D. Marker, Pleasant View, UT (US)

(21) Appl. No.: 18/093,051

(22) Filed: Jan. 4, 2023

(51) Int. Cl. G06N 3/02

(52) U.S. Cl. CPC G06N 3/02

(57) ABSTRACT

Embodiments relate to a method of efficient zero-padding in convolution. The method includes accessing a partition among a plurality of partitions of an input tensor. The input tensor is divided into the plurality of partitions in a raster-scan direction. For each row of a kernel for performing convolution on the input tensor, a register is populated with a set of values indicating a zero-padding pattern. For a compute cycle in the row of the kernel, computations associated with the convolution are performed based in part on the zero-padding pattern. After that, an updated zero-padding pattern representing a zero-padding pattern for a next cycle in the row of the kernel is generated. The set of values in the register is updated to the updated zero-padding pattern.

### BACKGROUND

### 1. Field of the Disclosure

The present disclosure relates to scheduling operations associated with neural networks, and more specifically to compiling operations of multiple tensor layers in a neural network into tasks that may be performed by a neural processor in a streaming manner.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of the CPU as well as increase the overall power consumption.

### SUMMARY

Embodiments relate to zero-padding in convolution performed by a neural processor circuit. A partition among a plurality of partitions of an input tensor having input elements stored in a buffer memory is accessed. The input tensor is divided into the plurality of partitions in a raster-scan direction.

For each kernel row for performing convolution on the input tensor, a register is populated with a set of values. The set of values represents a zero-padding pattern for a first cycle in the kernel row, in which each value corresponds to a compute circuit configured to perform computation associated with the convolution, and a compute circuit corresponding to an inactive value is to be ignored. After the computation of the first cycle in the kernel row is performed, an updated zero-padding pattern is generated. The updated zero-padding pattern represents a zero-padding pattern for a next cycle in the kernel row. This process may repeat as many times as necessary until all the compute cycles in the same kernel row are completed.

### BRIEF DESCRIPTION OF THE DRAWINGS

Figure (FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4A is a block diagram of a neural engine in the neural processor circuit, according to one embodiment.

FIG. 4B illustrates an example convolution operation performed in a streaming manner at the neural engine of FIG. 4A, according to one embodiment.

FIG. 5 illustrates an example of performing convolution operations on multiple convolution layers in a streaming manner, according to one embodiment.

FIG. 6 illustrates a 16×20×1 input tensor and a 3×3 kernel for performing convolution operation on the input tensor, according to one embodiment.

FIG. 7 illustrates a 32-byte wide memory having the 16×20×1 input tensor of FIG. 6 stored thereon, according to one embodiment.

FIGS. 8A and 8B illustrate 9 cycles of convolution performed over element (0, 0) of a 16×20×1 input tensor based on a 3×3 kernel, resulting in an output row edge at a left most position, according to one embodiment.

FIGS. 9A and 9B illustrate 9 cycles of convolution computation performed over element (0, 16) of a 16×20×1 input tensor based on a 3×3 kernel, resulting in an output row edge at a middle position, according to one embodiment.

FIGS. 10A and 10B illustrate 9 cycles of convolution computation performed over element (7, 4) of a 16×20×1 input tensor based on a 3×3 kernel, resulting in an output row edge at a right most position, according to one embodiment.

FIGS. 11A and 11B illustrate 9 cycles of convolution computation performed over element (14, 8) of a 16×20×1 input tensor based on a 3×3 kernel, resulting in an output row edge at a middle position, according to one embodiment.

FIGS. 12A and 12B illustrate 9 cycles of convolution computation performed over element (0, 16) of a 16×20×1 input tensor based on a 5×5 kernel, according to one embodiment.

FIGS. 13A through 13E illustrate an example embodiment of an edge register and a padded register, corresponding to cycles 11-15 of FIG. 12B, according to one embodiment.

FIGS. 13F through 13J illustrate an example embodiment of an edge register and a padded register, corresponding to cycles 6-10 of FIG. 12B, according to one embodiment.

FIGS. 13I through 13K illustrate an example embodiment of an edge register and a padded register, corresponding to cycles 1-3 of FIG. 10B, according to one embodiment.

FIGS. 13L through 13N illustrate an example embodiment of an edge register and a padded register, corresponding to cycles 7-9 of FIG. 11B, according to one embodiment.

FIG. 14 illustrates logic needed to initialize a padded register and datain bit corresponding to data elements passed to NEs in next cycles, according to one embodiment.

FIG. 15 is a flowchart illustrating a method of efficient zero-padding in convolution, according to one embodiment.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments relate to efficient zero-paddings of a convolutional layer by using zero-padding patterns. For each kernel row, a register (also referred to as “padded register”) is populated with a set of values, indicating a zero-padding pattern for a first cycle in the kernel row. For a compute cycle in the kernel row, computations associated with convolution are performed based in part on the zero-padding pattern. In particular, a result of a compute circuit corresponding to an active value in the set of values is kept; and a result of a compute circuit corresponding to an inactive value in the set of values is ignored. For example, in some embodiments, each value in the register is a binary value, where “1” is an active value, and “0” is an inactive value, or vice versa. After computations associated with convolution for the cycle are completed, an updated zero-padding pattern representing a zero-padding pattern for a next cycle in the kernel row is generated and populated in the padded register.

In some embodiments, generating a zero-padding pattern is based in part on an out-of-bound input elements or an output row edge. In some embodiments, for each partition, a second register (also referred to as “edge register”) is populated with a second set of values, indicating a position of the output edge row. Generating the updated zero-padding pattern includes performing an XOR operation between the set of values in the padded register and the second set of values in the edge register.

### Exemplary Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

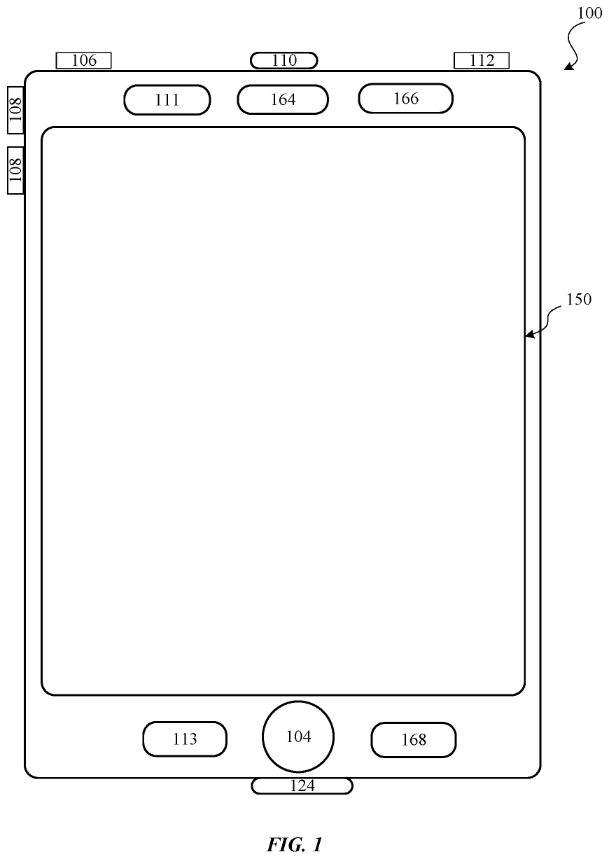

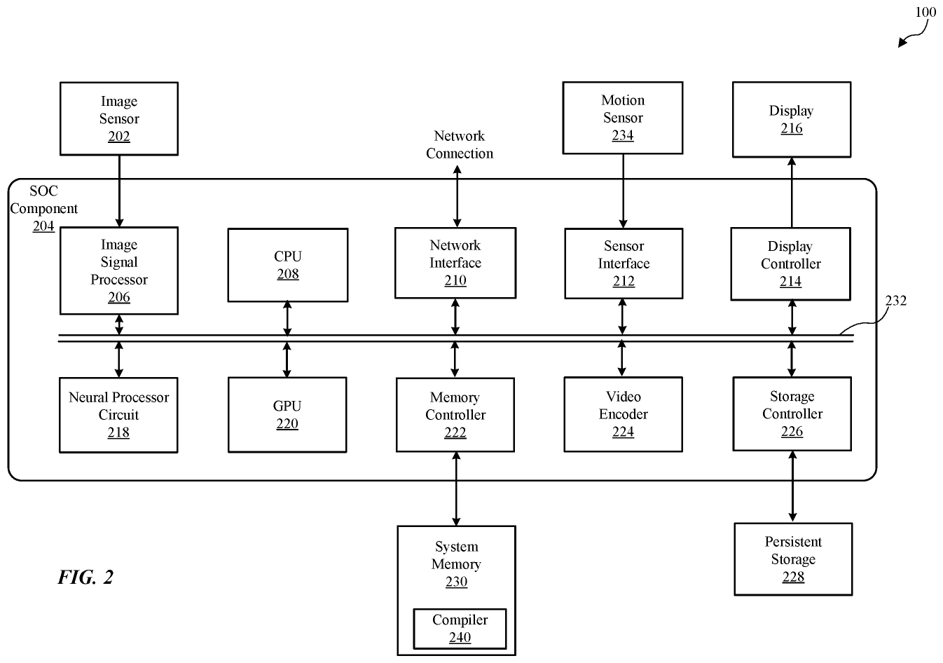

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

GPU 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

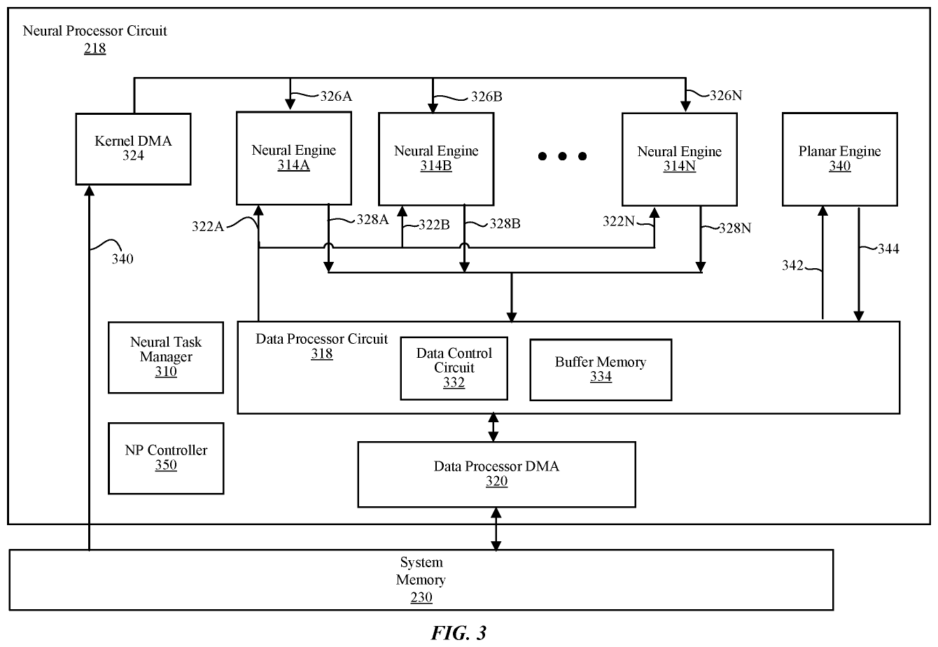

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, ISP 206, persistent storage 228, system memory 230 or other sources such as network interface 210 or GPU 220. The output of neural processor circuit 218 may be provided to various components of device 100 such as ISP 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to ISP 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

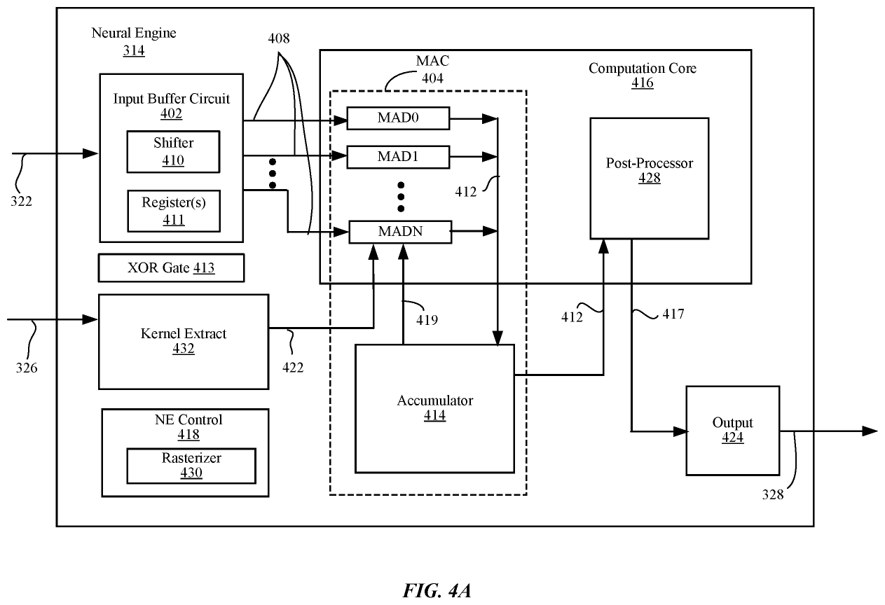

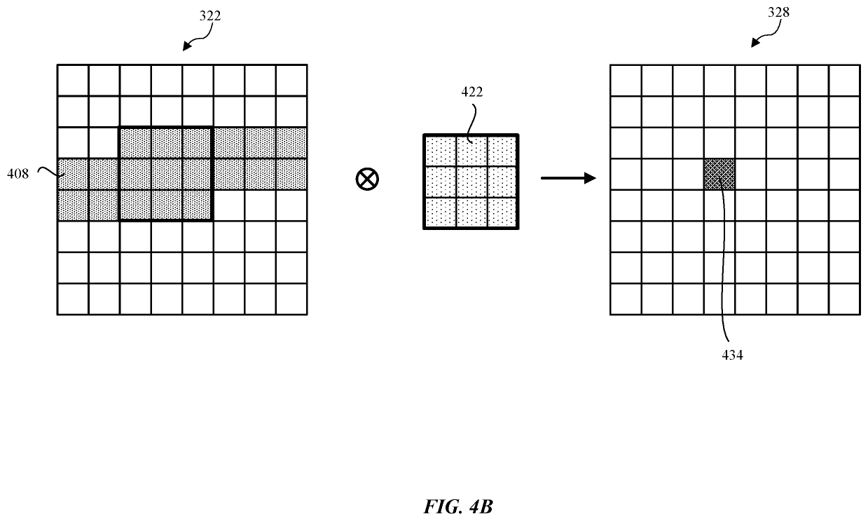

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4A. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions. Different neural engines 314 may process different tensor inputs. Alternatively, one neural engine 314 may process different tensor inputs.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar). In some embodiments, planar engine 340 is omitted from neural processor circuit 218.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data.

Data of neural processor circuit 218 includes input data that is transmitted from another source such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data from a source (e.g., system memory 230) and sends kernel data 326A through 326N to each of neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a data control circuit 332 and a buffer memory 334. Buffer memory 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In one embodiment, buffer memory 334 is embodied as a non-transitory memory that can be accessed by neural engines 314 and planar engine 340. Buffer memory 334 may be a direct memory access buffer that stores data of a machine learning model of device 100 without involvement of CPU 208. Buffer memory 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer memory 334 may also store input data 342 and output data 344 of planar engine 340 and allow the exchange of data between neural engine 314 and planar engine 340. For example, one or more output data 328A through 328N of neural engines 314 are used as input data 342 to planar engine 340. Likewise, output data 344 of planar engine 340 may be used as input data 322A through 322N of neural engines 314. The inputs of neural engines 314 or planar engine 340 may be any data stored in buffer memory 334. For example, in various operating cycles, the source datasets from which one of the engines fetches as inputs may be different. The input of an engine may be an output of the same engine in previous operating cycles, outputs of different engines, or any other suitable source datasets stored in buffer memory 334. Also, a dataset in buffer memory 334 may be divided and sent to different engines for different operations in the next operating cycle. Two datasets in buffer memory 334 may also be joined for the next operation.

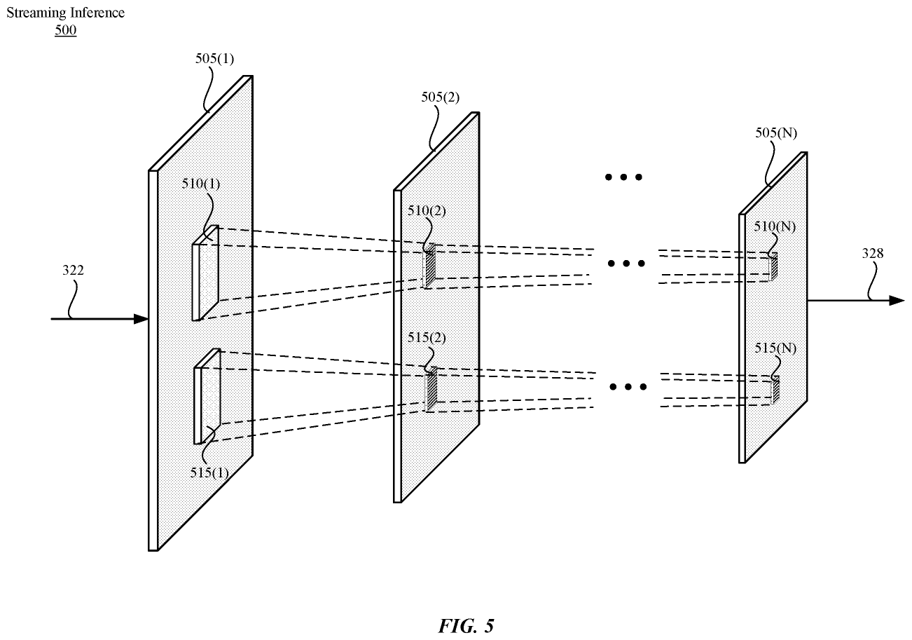

Buffer memory 334 may include multiple tensor buffers for storing portions of input data 322A through 322N and portions of output data 328A through 328N for access by one or more neural engines 314 to perform the streaming convolution operations. Details about structure and operations of buffer memory 334 for supporting the streaming convolution operations at one or more neural engines 314 are described below in with reference to FIG. 5.

Data control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Data control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to planar engine 340 to direct planar engine 340 to program itself for operating in one of multiple operation modes. Details about operations of data control circuit 332 are described below in with reference to FIG. 5.

The data of neural processor circuit 218 stored in buffer memory 334 may be part of, among others, image data, histogram of oriented gradients (HOG) data, audio data, metadata, output data 328 of a previous operating cycle of neural engine 314, and other processed data received from other components of SOC component 204.

Data processor DMA 320 includes a read circuit that receives a portion of input data from a source (e.g., system memory 230) for storing in buffer memory 334, and a write circuit that forwards data from buffer memory 334 to a target component (e.g., system memory 230). In one embodiment, the direct memory access nature of data processor DMA 320 may allow data processor DMA 320 to fetch and write data directly from a source (e.g., system memory 230) without the involvement of CPU 208. Buffer memory 334 may be a direct memory access buffer that stores data of a machine learning model of device 100 without the involvement of CPU 208.

Neural Processor (NP) controller 350 is a control circuit that performs various operations to control the overall operation of neural processor circuit 218. NP controller 350 may interface with CPU 208, program components of neural processor circuit 218 by setting register in the components and perform housekeeping operations. NP controller 350 may also initialize components in neural processor circuit 218 when neural processor circuit 218 is turned on.

### Example Neural Engine Architecture

FIG. 4A is a block diagram of neural engine 314, according to one embodiment. Neural engine 314 performs various operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator circuit 414 and output circuit 424. Neural engine 314 may include fewer components than what is illustrated in FIG. 4A or include further components not illustrated in FIG. 4A.

Kernel extract circuit 432 is a circuit that receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate register in multiply-add (MAD) circuits of computation core 416. In other embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include MAD circuits MAD0 through MADN and a post-processor 428. Each of MAD circuits MAD0 through MADN may store an input value in segment 408 of the input data and a corresponding kernel coefficient in kernel coefficients 422. The input value and the corresponding kernel coefficient are multiplied in each of MAD circuits to generate a processed value 412.

Accumulator circuit 414 is a memory circuit that receives and stores processed values 412 from MAD circuits. The processed values stored in accumulator circuit 414 may be sent back as feedback information 419 for further multiply and add operations at MAD circuits or sent to post-processor 428 for post-processing. Accumulator circuit 414 in combination with MAD circuits form a multiply-accumulator (MAC) 404. In one or more embodiments, accumulator circuit 414 may have subunits (or batches) where each subunit sends data to different components of neural engine 314. For example, during an operating cycle, data stored in a first subunit of accumulator circuit 414 is sent to MAC 404 while data stored in a second subunit of accumulator circuit 414 is sent to post-processor 428.

Post-processor 428 is a circuit that performs further processing of values 412 received from accumulator circuit 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at post-processor 428 is bypassed. For example, the data in accumulator circuit 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed during a prior operating cycle of neural engines 314 having a size that produces output values that fit into accumulator circuit 414 of neural engine 314 during a single operating cycle of computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior operating cycle of planar engine 340 that can be processed simultaneously at planar engine 340.

Rasterizer 430 may perform the operations associated with dividing the input data into smaller units (segments) and regulate the processing of the smaller units through MACs 404 and accumulator circuit 414. Each of the smaller units is also referred to as a partition. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., kernel DMA 324, buffer DMA 320, buffer memory 334, planar engine 340) may also have their corresponding rasterizers to monitor the division of input data and the parallel computation of various segments of input data in different components.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Input buffer circuit 402 may also include a plurality of registers 411. In some embodiments, the plurality of registers 411 includes a first register and a second register. The first register and the second register are loaded based on a zero-padding pattern and a position of the output row edge, which are determined by the NE control 418. In some embodiments, for each partition, the NE control 418 identifies an output edge row for each partition. For each kernel row, the NE control 418 generates a zero padding pattern.

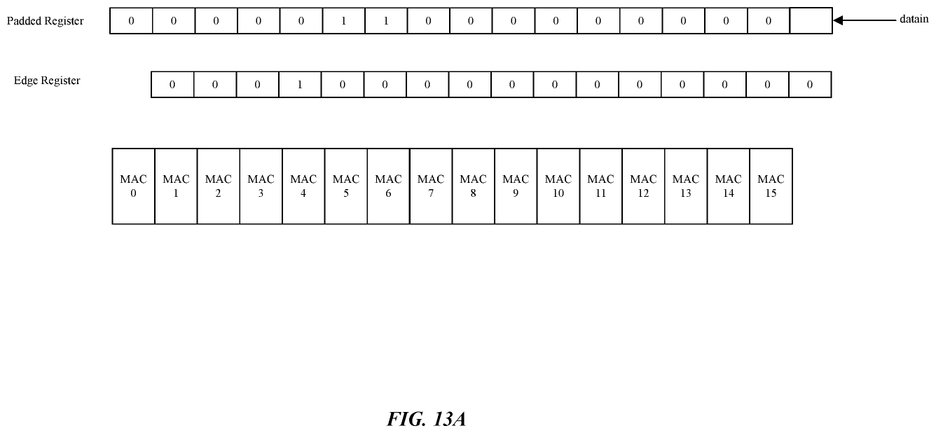

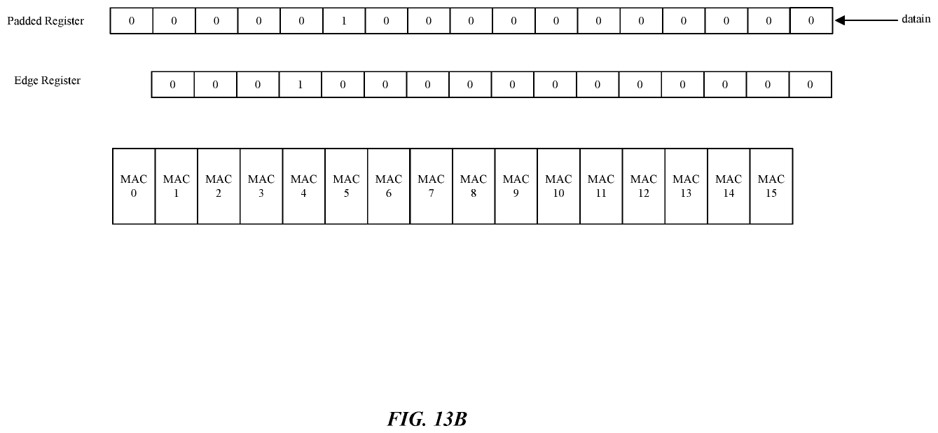

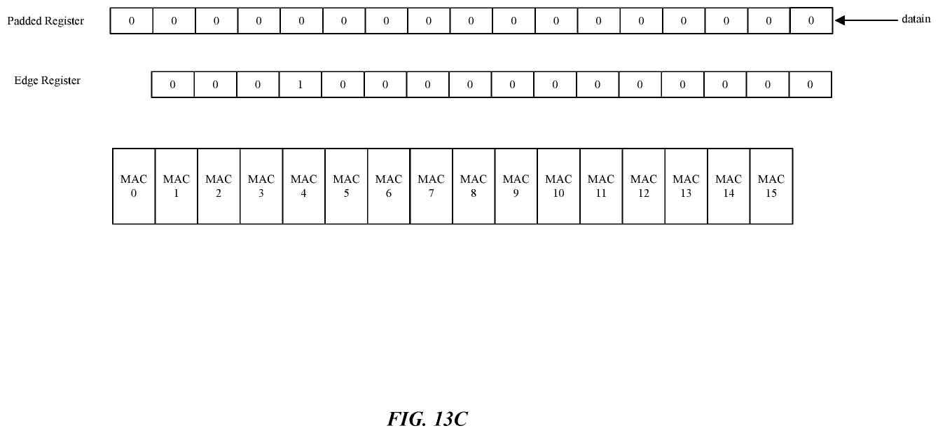

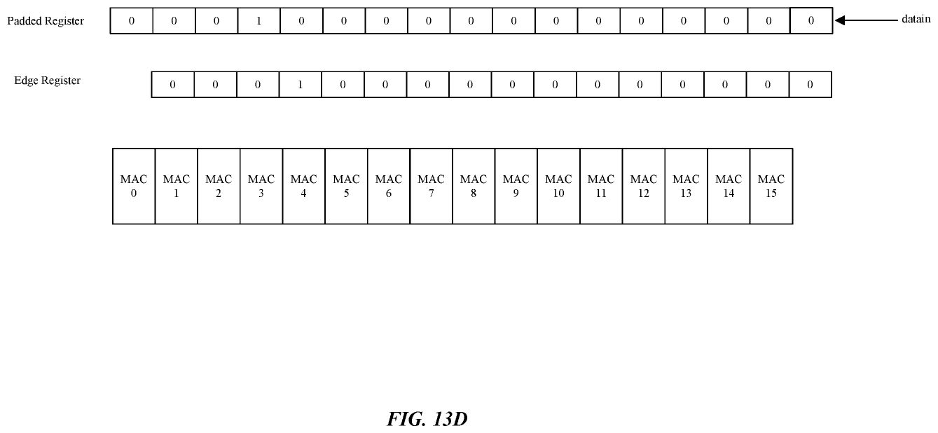

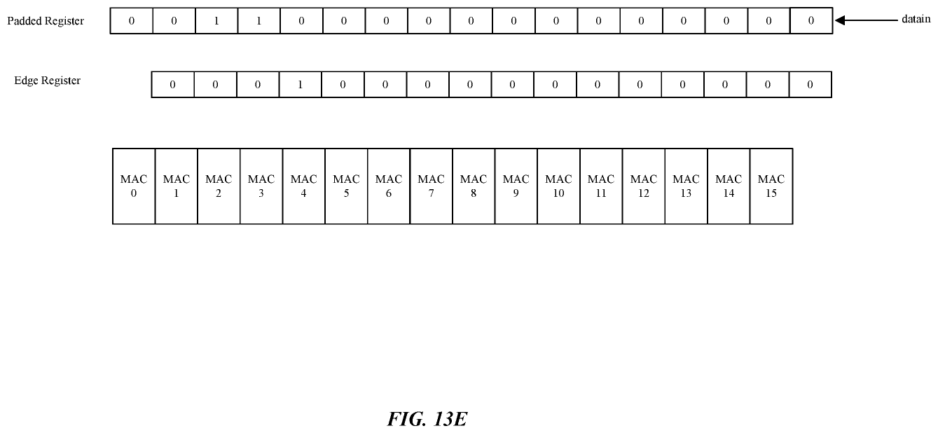

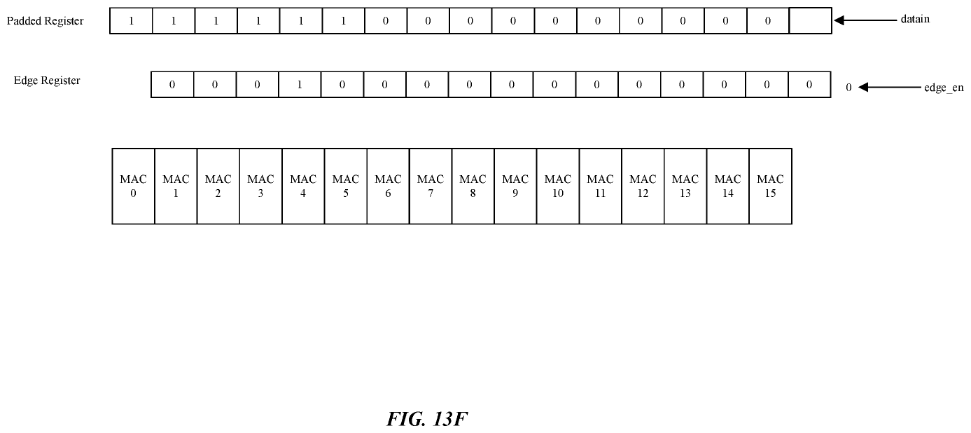

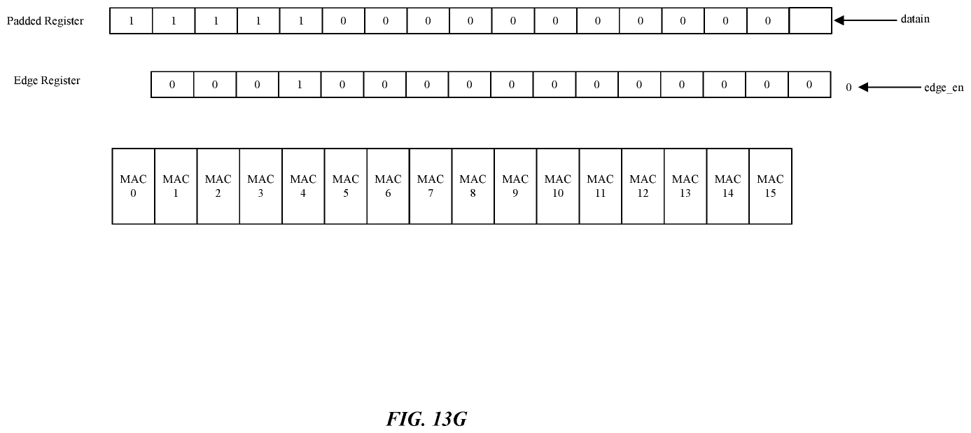

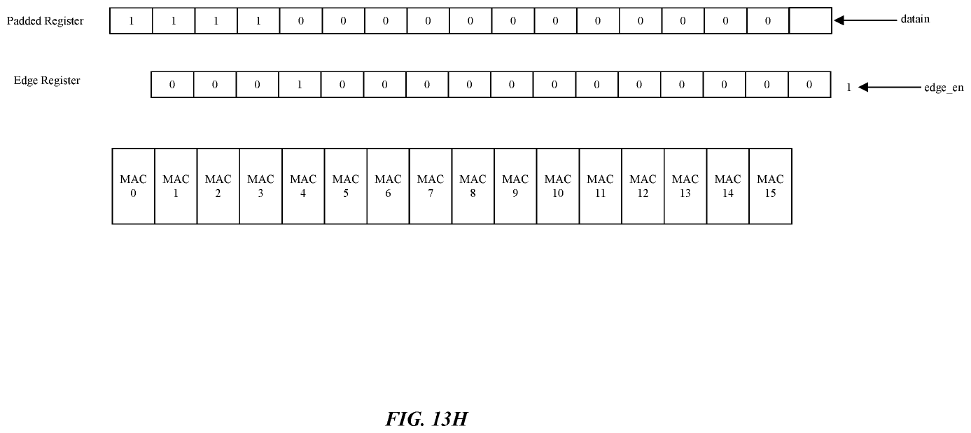

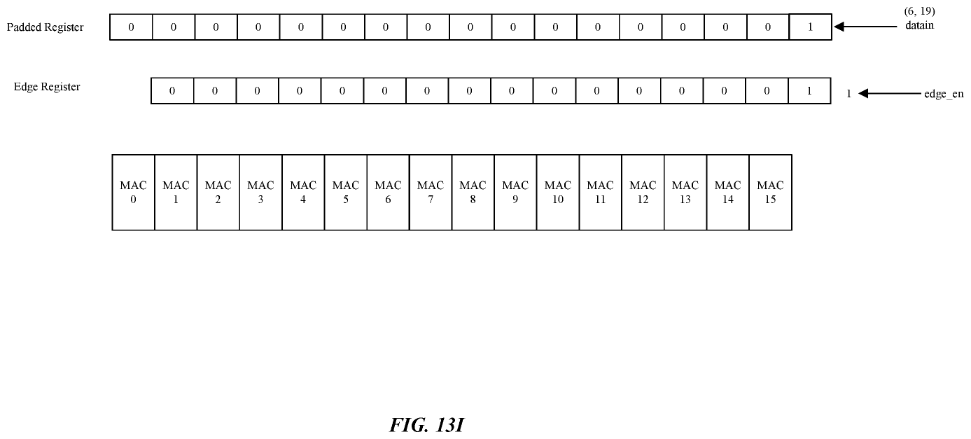

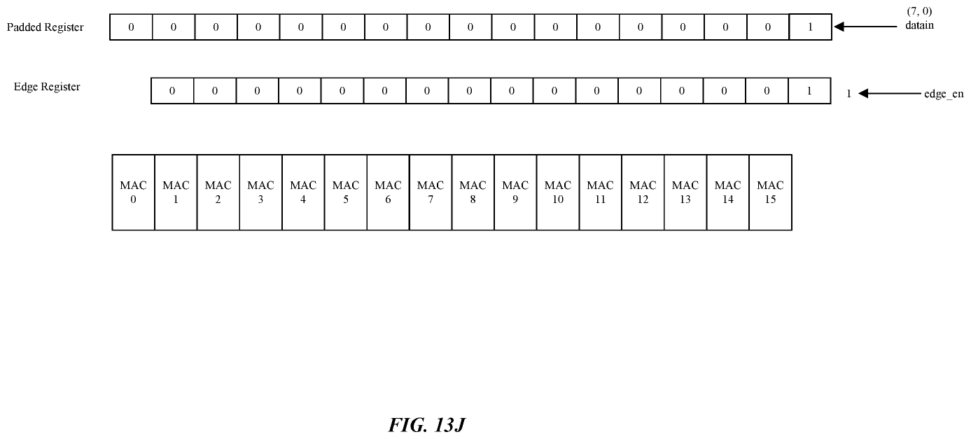

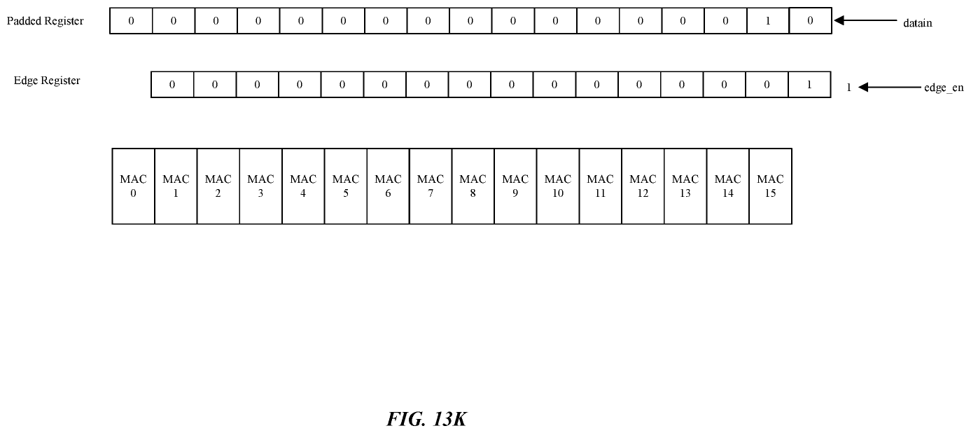

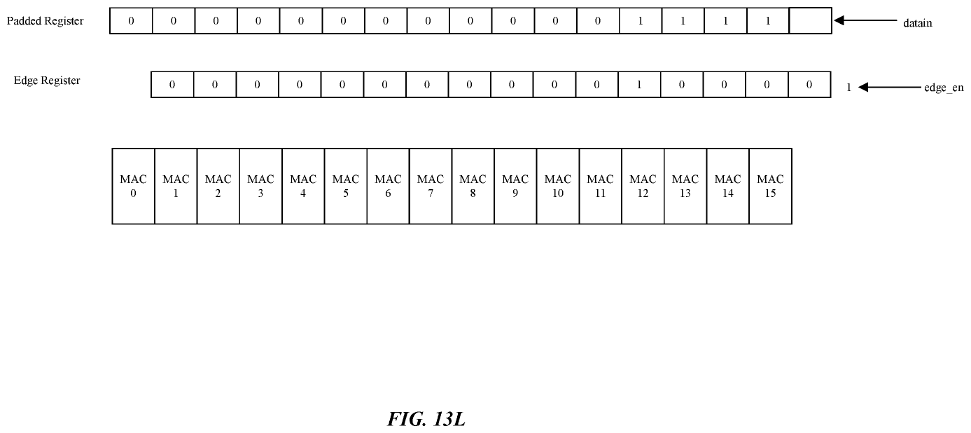

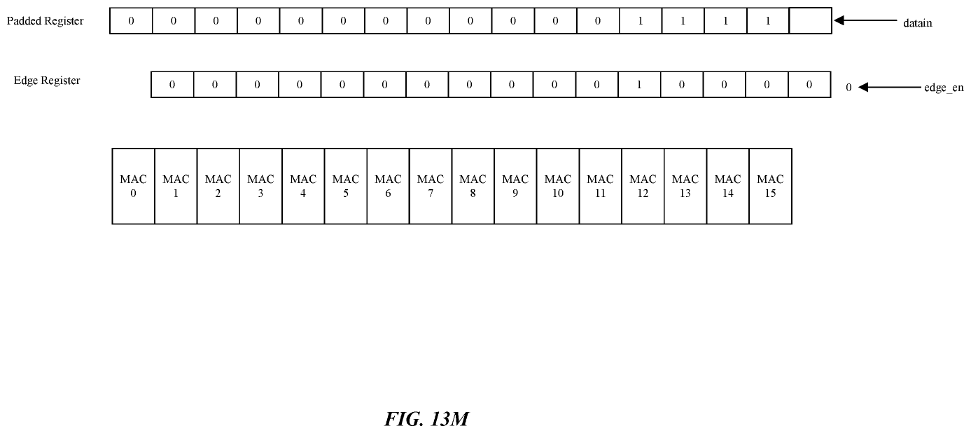

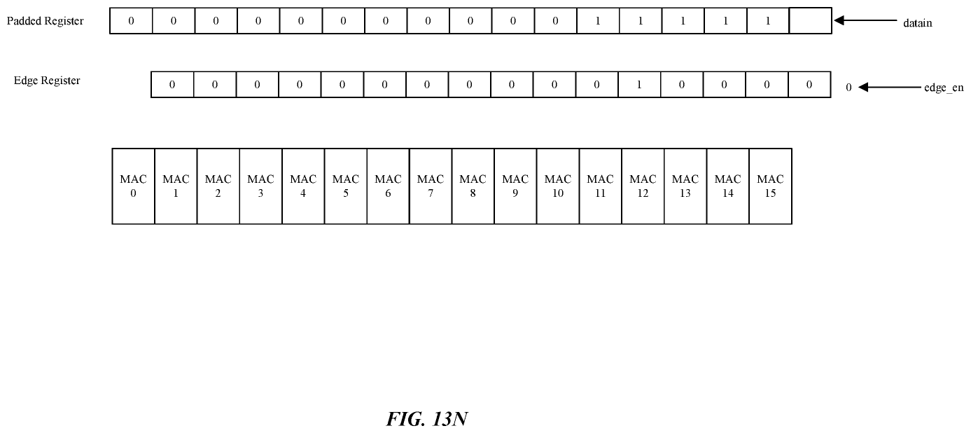

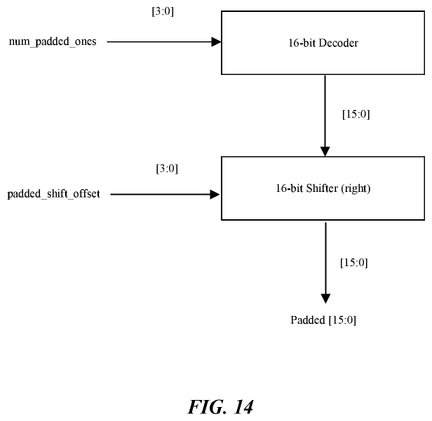

In particular, the first register (also referred to as “padded register”) is loaded based on a zero-padding pattern, where an inactive value (e.g., 1) indicates that a corresponding MAC is to be ignored. The second register (also referred to as “edge register”) is loaded with values based on a position of an output row edge, where a value (e.g., 1) indicates that a corresponding input element is the position of the output row edge. The edge register is set or reloaded once per partition. Each input tensor is divided into a plurality of equal-sized partitions (e.g., 16 elements) in a raster scan direction. Each partition may be loaded into and computed by one of the NEs, and each element corresponds to each MAC. The padded register is set or reloaded at beginning of each kernel row. After that, the padded register is updated every cycle based on a predetermined XOR logic. Additional details related to loading and updating the padded register and edge register are further discussed below with respect to FIGS. 13A-14.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Streaming Convolution

Embodiments of the present disclosure relate to performing streaming convolution operations. In the streaming convolution operations, multiple layers of a CNN execute convolution operations in parallel, either physically or virtually. Each layer may stream the most recent computed results immediately to the next convolutional layer. Additionally, buffers associated with each layer may store only a part of input data as needed for its convolution operations, instead of the entire input tensor (as it would be done in the layer-by-layer inference). Hence, the memory footprint required for streaming convolution operations becomes equal to a sum of tensor buffers used for storage of partial input tensors. On the other hand, the memory footprint required for the layer-by-layer inference depends on a layer that requires the largest total memory size to store input and output tensors simultaneously, which can be substantially larger than the required memory footprint for the streaming convolutions. Furthermore, performing convolution operations in a streaming manner can also improve an overall latency of the CNN. In the case of streaming convolution operations, a first output element (e.g., pixel value) of an output tensor of the CNN can be computed as soon as enough input data is fed to a neural engine circuit. Hence, a first-pixel-to-first-pixel latency of the CNN implemented at the neural engine circuit as streaming convolution operations can be significantly better compared to a first-pixel-to-first-pixel latency of a CNN implemented at a neural engine circuit as layer-by-layer convolution operations.

FIG. 4B illustrates an example convolution operation performed in a streaming manner at neural engine 314, according to one embodiment. The example convolution operation of FIG. 4B is a convolution of kernel coefficients 422 of size 3 by 3 by 1 with input data 322 (e.g., input tensor) of size 10 by 10 by 1 (e.g., monochrome image data), which generates output data 328 (e.g., output tensor) of size 10 by 10 by 1. The example convolution operation of FIG. 4B can be a convolution operation of one convolution layer out of multiple convolution layers in a CNN. Segment 408 of the input data may stream in from a previous layer (e.g., in raster-scan, left-to-right and then top-to-bottom). Alternatively, segment 408 of the input data may be received from system memory 230 or from image signal processor 206. To compute an output element 434 in output data 328, neural engine 314 would only process segment 408 of the input data. Thus, only segment 408 of the input data corresponding to a partial input tensor (e.g., two rows and two input elements of input data 322) may be stored in, e.g., buffer memory 334 to generate output element 434.

In the next computational cycle, a new input element of input data 322 would arrive (e.g., from buffer memory 334) as being generated from the previous layer, and consequently, neural engine 314 would compute a next output element of output tensor 328. However, a size of the partial input tensor stored in buffer memory 334 does not change, and older input element(s) of input data 322 can be evicted from buffer memory 334 since the older input element(s) of input data 322 are not used for processing again. Hence, for the streaming convolution operations, only the partial input tensor (e.g., two rows and two input elements of input data 322) may be stored in buffer memory 334, instead of buffering the entire input data 322.

### Example Zero-Padding Pattern Generation in 2D Convolution

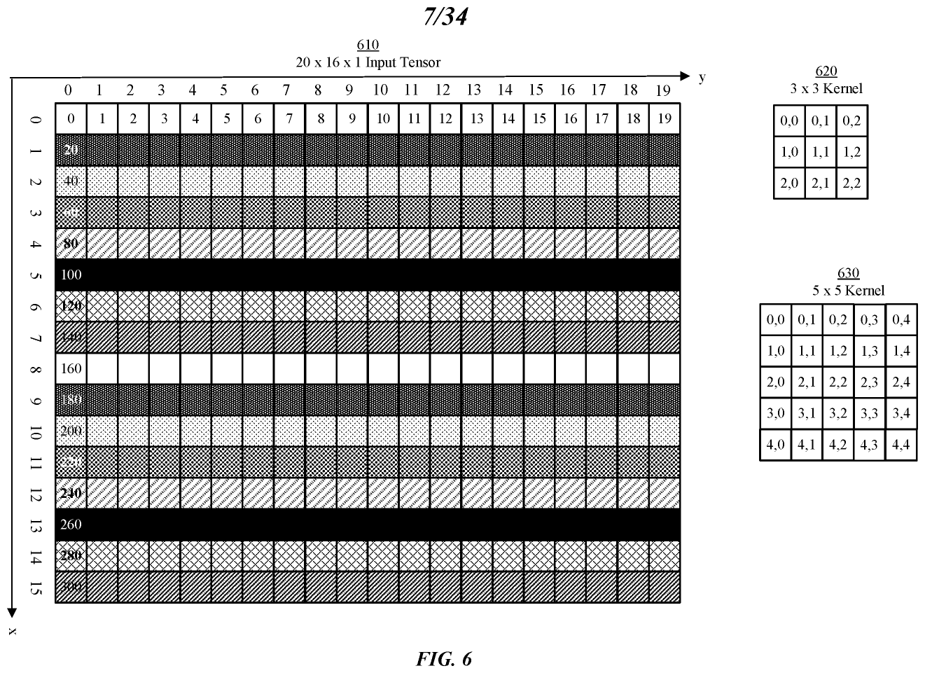

FIG. 6 illustrates an example 16×20×1 input tensor 610, a 3×3 kernel 620, or a 5×5 kernel 630 for performing convolution operations on 16×20×1 input tensor 610, in accordance with an embodiment. For easier reference, each element in the input tensor 610 may be referred to as (x, y) based on its index number along x-axis and y-axis. For example, a first element in the top row may be referred to as (0, 0), a second element in the top row may be referred to as (0, 1), and so on and so force.

Similarly, each element in 3×3 kernel 620 or 5×5 kernel 630 may also be referred to as (X, Y) based on their index number in the x-axis direction and y-axis direction. For example, a leftmost element in the top row of kernel 620 or 630 is referred to as (0, 0), a second element in the top row of kernel 620 or 630 is referred to as (0, 1), and so on and so forth.

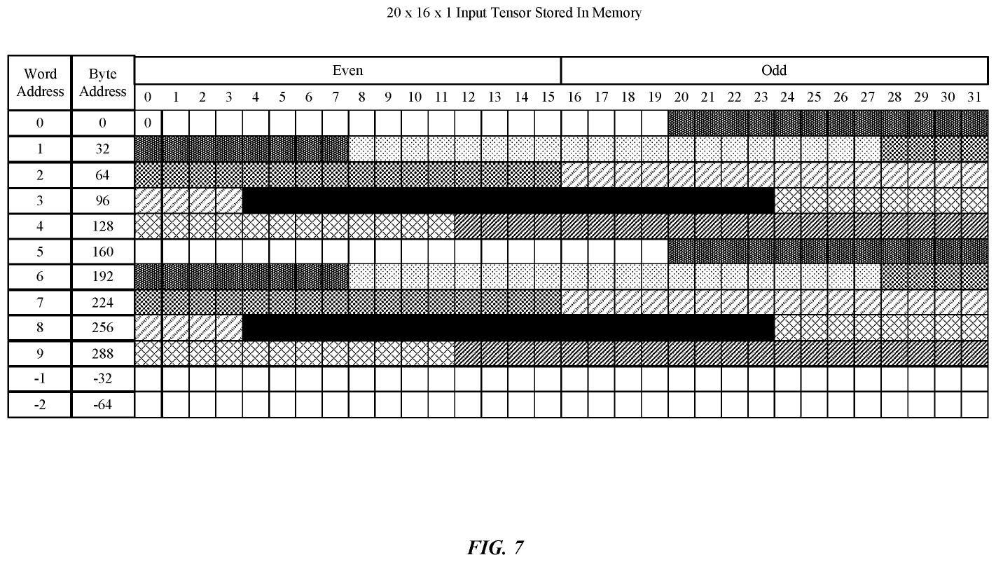

FIG. 7 illustrates a 32-Byte-wide memory 700 (e.g., TMEM)) sequentially storing elements of 16×20×1 input tensor 610 of FIG. 6. Memory 700 may be buffer memory 334 of FIG. 3 and/or input buffer circuit 402. As illustrated in FIGS. 6 and 7, tensor 610 has a width of 20 elements, each of which takes up a byte of memory 700. As illustrated in these figures, the memory has a width of a DWORD, which may be 4 bytes. In some embodiments, the memory may have a different width, such as a WORD, which is 2 bytes; or a QWORD, which is 8 bytes. The two bottom rows of the memory having negative addresses may correspond to out-of-bound elements in the input tensor.

Further, the elements of input tensor 610 are sequentially stored in memory 700. As such, each element corresponds to a byte address sequentially. For example, element (0, 0) is stored at a location corresponding to byte address 0; element (0, 1) is stored at a location corresponding to byte address 1, and so on and so forth. In some cases, the input tensor 710 may not be stored at a location starting with a byte address 0. For example, the byte address may start from any number N. However, regardless of the starting byte address, the relevant locations of the different elements in input tensor 610 are generally the same. For example, if element (0, 0) is stored at a location with a byte address N, element (0, 1) should be stored at a location with a byte address N+1. Also, in some embodiments, each element may take up more or less than a byte. In such a case, the increment of the byte address between two sequential elements may also change.

Referring back to FIG. 6, the byte addresses of the elements in the top row and the left column are listed therein for easier reference. For example, the first element in the second row (e.g., element (1, 0)) in FIG. 6 corresponds to byte address 20; the second element in the second row (e.g., element (1, 1)) in FIG. 6 corresponds to byte address 21, and so on and so forth.

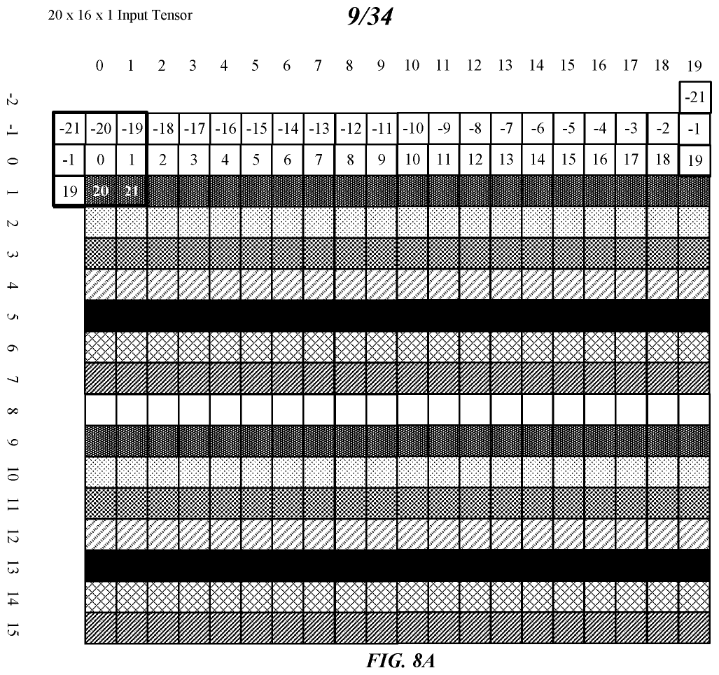

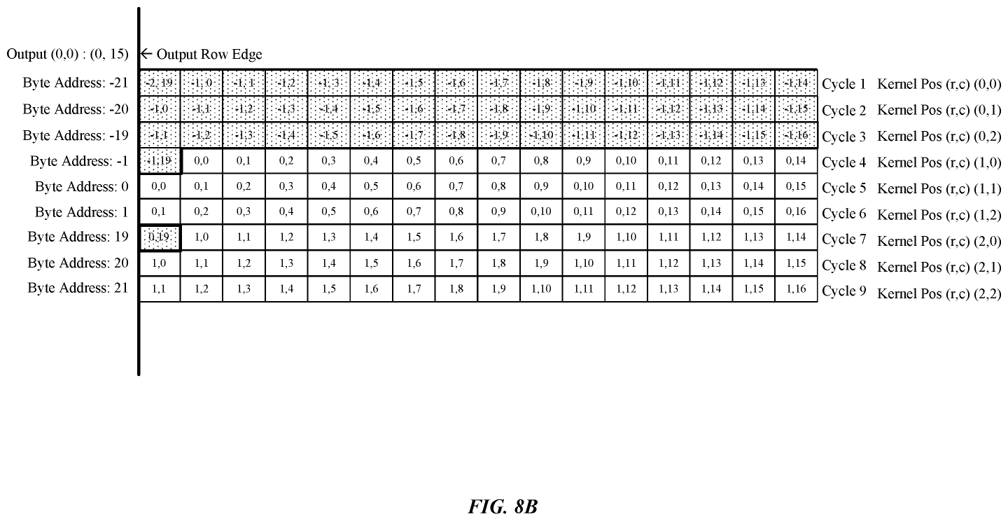

FIGS. 8A and 8B illustrate an example of applying the 3×3 kernel 620 to element (0, 0) of the input tensor 610 to generate element (0, 0) of an output tensor having a same shape and size (16×20×1) as the input tensor 610. As illustrated in FIG. 8A, the 9 elements of the 3×3 kernel 620 are applied to a 3×3 patch of the input tensor 610, with element (0, 0) in the center.

Since element (0, 0) is the first element in the input tensor 610, the topmost and leftmost elements in the 3×3 patch of the input tensor 610 are out-of-bound elements, which are represented based on the same x, y coordinate scheme. The first out-of-bound row above row 0 is denoted as row −1, and a second out-of-bound row above row −1 is denoted as row −2. As illustrated, the 3×3 patch of the input tensor 610 includes elements (−2, 19), (−1, 0), (−1, 1), (−1, 19), (0, 0), (0, 1), (0, 19), (0, 1), and (1, 1).

The number in each tensor element represents a corresponding byte address of the memory that stores the tensor element. Assuming that a byte address of element (0, 0) is 0, these out-of-bound elements are sequentially stored in addresses −1 through −21. The 3×3 patch of the input tensor 610 may be stored at locations with byte address −21, −20, −19, −1, 0, 1, 19, 20, 21.

FIG. 8B is a table 800B having 16 columns (corresponding to 16 MAC) and 9 rows (corresponding to 9 cycles). Assuming each NE has 16 MACs, each of which corresponds to a column of table 800B, the 16 cells of each row represent data elements of input tensor 610 and their corresponding addresses that the 16 MACs will receive. In particular, each row of table 800B shows which input element of the input tensor 610 and its byte address of the memory 700 should be accessed in 9 consecutive cycles of convolution performed over element 0 of the input tensor 610 based on 3×3 kernel 620 to find a first 16 elements of a first row of the output tensor. As such, the output row edge is at the leftmost position. As illustrated in FIG. 8B, the dotted elements are to be ignored by the MAC because they are (1) out-of-bound elements or (2) belong to a different row in the input tensor 610 compared to other elements in the same cycle. For example, referring back to FIG. 8A, cells (−2, 19) through (−1, 19) in the first four cycles are out-of-bound elements. Thus, these out-of-bound elements are to be zero-padded. As another example, element (0, 19) in cycle 7 belongs to the first row of the tensor 610, while other elements (1,0) through (1, 14) in the same cycle belong to the second row of the tensor 610. Thus, element (0, 19) belongs to a different row of the tensor compared to the rest of the elements in the same cycle, and it is to be zero-padded.

In particular, during the first cycle, kernel element (0, 0) is applied to an out-of-bound element (−2, 19) with a byte address −21. Thus, during the first cycle, all 16 data elements consecutively stored at byte address −21 are accessed, including (−2, 19), (−1, 0), (−1, 1) . . . (−1, 14). During the second cycle, kernel element (0, 1) is applied to an out-of-bound element (−1, 0) with a byte address −20. Thus, during the second cycle, all 16 data elements consecutively stored at byte address −20 are accessed, including (−1, 0), (−1, 1), (−1, 2) . . . (−1, 15). During the third cycle, kernel element (0, 2) is applied to an out-of-bound element (−1, 1) stored in byte address −19. Thus, during the third cycle, all 16 data elements consecutively stored at byte address −20 are accessed, including (−1, 1), (−1, 2), (−1, 3) . . . (−1, 16). All the elements in the first three cycles are to be zero-padded because they are out-of-bound elements.

Again, during the fourth cycle, kernel element (1, 0) is applied to an out-of-bound element (−1, 19) with a byte address −1. Thus, during the third cycle, all 16 data elements consecutively stored at byte address −1 are accessed, including (−1, 19), (0, 0), (0, 1) . . . (0, 14). In this cycle, only the first element (−1, 19) is an out-of-bound element, and it is zero-padded. Alternatively, the element (−1, 19) also belongs to a different row compared to the rest of the elements in the cycle. Thus, for either the out-of-bound reason or out-of-row reason, the element (−1, 19) should be zero-padded.

During the fifth cycle, kernel element (1, 1) is applied to element (0, 0) with a byte address 0. Thus, during the fifth cycle, all data elements consecutively stored at byte address 0 are accessed, including (0, 0) through (0, 15). During the sixth cycle, kernel element (1, 2) is applied to element (0, 1) with a byte address 1. Thus, during the sixth cycle, all data elements consecutively stored at byte address 1 are accessed, including (0, 1) through (0, 16). Notably, all the elements in the fifth and sixth cycles are not out-of-bound elements, and they belong to the same row of the input tensor. Thus, they are not zero-padded.

During the seventh cycle, kernel element (2, 0) is applied to element (0, 19) with a byte address 19. Thus, during the seventh cycle, all data elements sequentially stored at byte address 19 are accessed, including (0, 19), (1, 0) through (1, 14). Although all the elements in the seventh cycle are not out-of-bound elements, the first element (0, 19) belongs to the first row of the input tensor, and the rest of the elements (1, 0) through (1, 14) belong to the second row of the input tensor. Thus, the first element (0, 19) is zero-padded.

This process repeats for the eighth cycle and the ninth cycle. In the eighth cycle, kernel element (2, 1) is applied to element (1, 0) with a byte address 20. In the ninth cycle, kernel element (2, 2) is applied to element (1, 1) with a byte address 21. In these two cycles, all the elements accessed belong to the second row of the input tensor, and no elements need to be zero-padded in these cycles.

As shown in FIGS. 8A and 8B, a zero-padding scheme may be identified as (1) when a kernel row is out of boundaries, horizontal padding is performed, e.g., all the out-of-bound elements are zero-padded, e.g., during the first three cycles, and (2) when an output row edge is on the leftmost position, zero-pad only the element next to the output row edge when the element is from a different row compared to the rest of the element in the cycle.

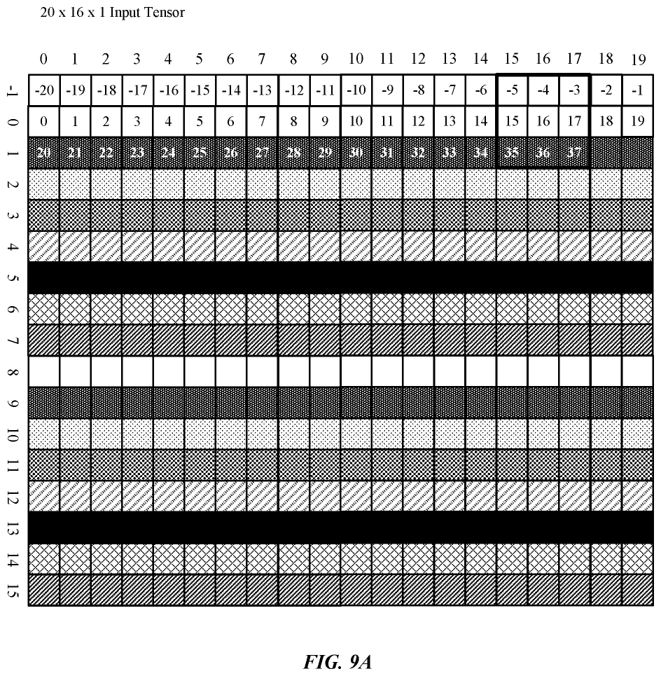

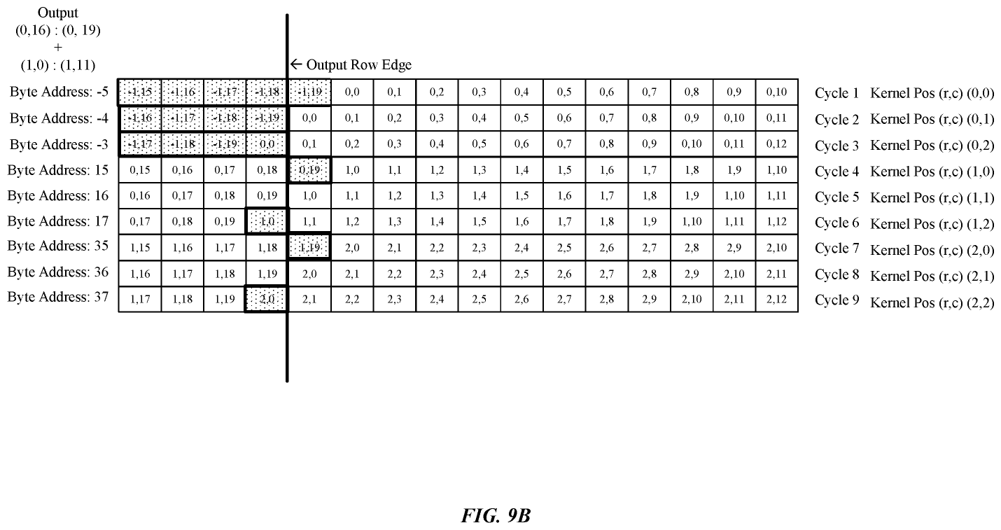

FIGS. 9A and 9B illustrate an example of applying the 3×3 kernel 620 to element (0, 16) of the input tensor 610 to generate element (0, 16) of an output tensor having a same shape and size (16×20×1) as the input tensor 610. As illustrated in FIG. 9A, the 9 elements of the 3×3 kernel 620 are applied to a 3×3 patch of the input tensor 610, with element (0, 16) in the center. Similar to FIG. 8A, the number in each tensor element of FIG. 9A represents a byte address of the memory that stores the corresponding tensor element. Since element (0, 16) is an element of a top row in the input tensor 610, the topmost elements (−1, 15), (−1, 16), and (−1, 17) are all out-of-bound elements.

FIG. 9B is a table 900B having 16 columns (corresponding to 16 MACs) and 9 rows (corresponding to 9 cycles). Again, assuming each NE has 16 MACs, the 16 cells in each row of table 900B represent addresses of data elements of input tensor 610 and their corresponding addresses that the 16 MACs will receive. In particular, each row of table 900B shows which input element of the input tensor 610 and its byte address of the memory 700 should be accessed in 9 consecutive cycles of convolution performed over element 16 of the input tensor 610 based on the 3×3 kernel 620 to find 4 last pixels of the first row and first 12 pixels of the second row of the output tensor. As such, the output row edge is in the middle of the row as shown in FIG. 9B.

During the first cycle, kernel element (0, 0) is applied to an out-of-bound element (−1, 15) with a byte address −5. All 16 data elements consecutively stored at byte address −5 are accessed, including (−1, 15) through (−1, 19), and (0, 0) through (0, 10). During the second cycle, kernel element (0, 1) is applied to an out-of-bound element (−1, 16) with a byte address −4. All 16 data elements consecutively stored at byte address −4 are accessed, including (−1, 16) through (−1, 19), and (0, 0) through (0, 11). During the third cycle, kernel element (0, 2) is applied to an out-of-bound element (−1, 17) with a byte address −3. All 16 data elements consecutively stored at byte address −3 are accessed, including (−1, 17) through (−1, 19) and (0, 0) through (0, 12). This process repeats for all 9 cycles.

Referring to FIG. 9B, all the out-of-bound elements (shaded with dots) are zero-padded during the first three cycles. On cycle 4, only the element (0, 19) on the right side of the output row edge should be zero padded since it is out the boundaries of second row. On cycle 5, no zero padding is needed. On cycle 6, the element (1, 0) on the left side of the output row edge line should be zero padded since it belongs to a next row. Cycles 7-9 are identical to cycles 4-6 in terms of zero-padding. As such, when the output row edge is in the middle, the zero padding scheme may be identified as, an element either on left or right of the output row edge line is zero-padded when two adjacent elements of the element are from different rows.

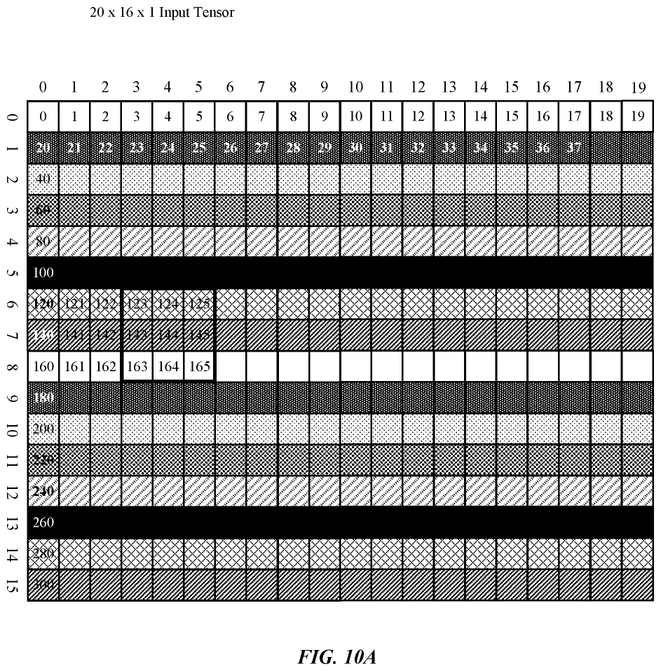

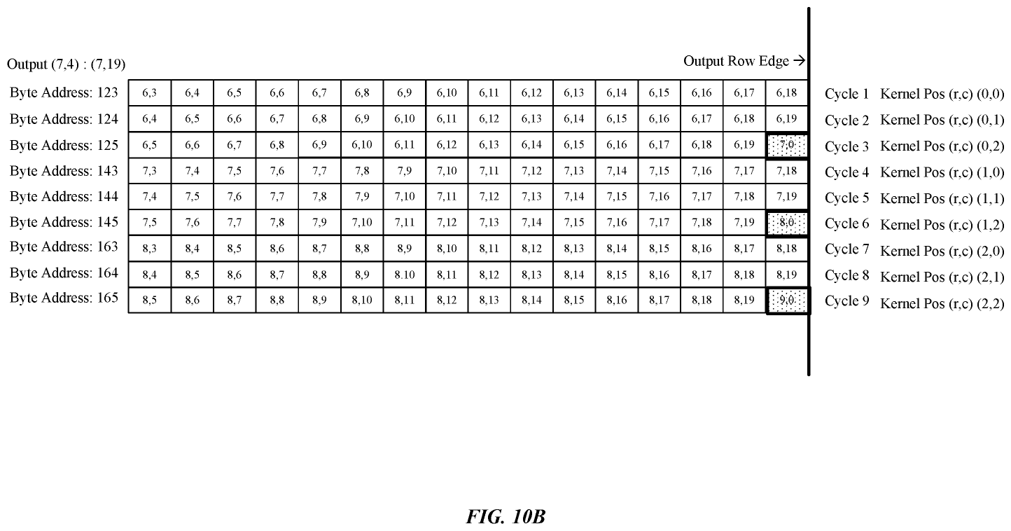

FIGS. 10A and 10B illustrate an example of applying the 3×3 kernel 620 to element (7, 4) of the input tensor 610 to generate element (7, 4) of an output tensor having a same shape and size (16×20×1) as the input tensor 610. As illustrated in FIG. 10A, the 9 elements of the 3×3 kernel 620 are applied to a 3×3 patch of the input tensor 610 with element (7, 4) in the center.

Again, assuming each NE has 16 MACs, the 16 cells in each row of table in FIG. 10B represent addresses of data elements of input tensor 610 and their corresponding addresses that the 16 MACs will receive. In particular, each row of the table 1000B shows which input element of the input tensor 610 and its byte address of the memory 700 should be accessed in 9 consecutive cycles of convolution performed over element 0 of the input tensor 610 based on 3×3 kernel 620 to find the last 16 elements in the eighth row of the output tensor. As such, the output row edge is at the rightmost position as shown in FIG. 10B.

Since element (7, 4) is in the middle of the input tensor 610, all the elements in the 3×3 patch are within the input tensor 610, and none of the elements are out of bound. As such, there is no zero-paddings based on out-of-bound elements, although zero-paddings are performed on the edge of the two rows. As shown in FIG. 10B, in cycles 3, 6, and 9, the element next to the output row edge should be zero padded, since they belong to an element from another row. As such, when the output row edge is at the right most position, the zero-padding scheme may be identified as zero-padding an element that is next to the output row edge if the element belongs to a different row from the rest of the elements in the cycle.

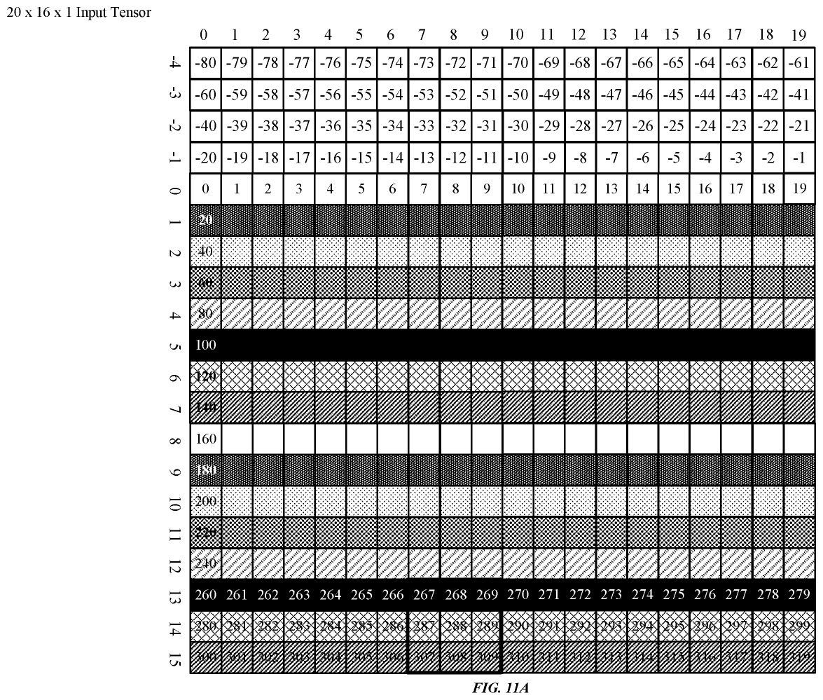

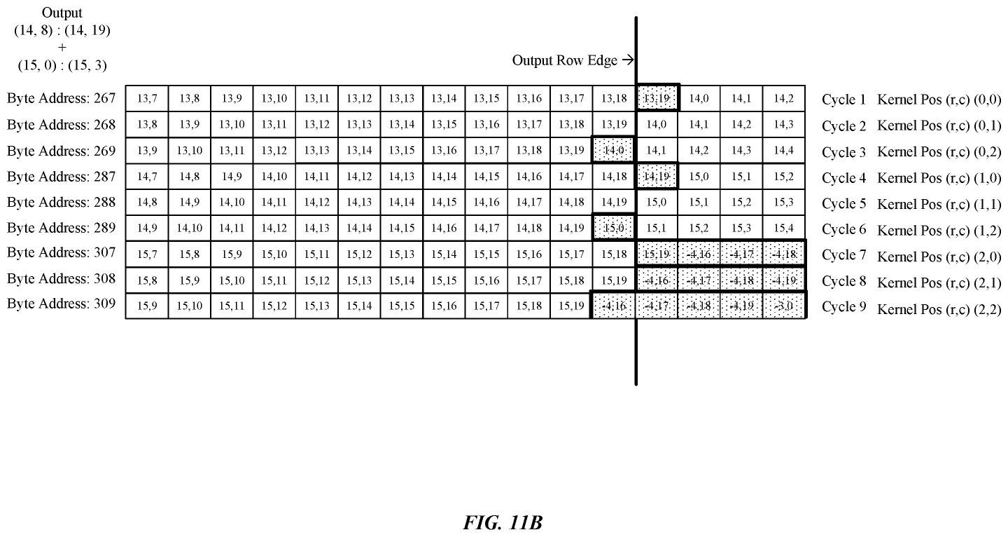

FIG. 11A illustrates another example situation when the 3×3 kernel 620 is applied to element (14, 8) of the input tensor 610, in accordance with one embodiment. As illustrated in FIG. 11A, the 9 elements of the 3×3 kernel 620 are applied to a 3×3 patch of the input tensor 610, with element (14, 8) in the center.

Again, assuming each NE has 16 MACs, the 16 cells in each row of table in FIG. 11B represent addresses of data elements of input tensor 610 and their corresponding addresses that the 16 MACs will receive. In particular, each row of the table 1100B shows which input element of the input tensor 610 and its byte address of the memory 700 should be accessed in 9 consecutive cycles of convolution performed over element 0 of the input tensor 610 based on 3×3 kernel 620 to find the last 12 elements of the 15th row and the first 4 elements of the 16th row of the output tensor. As such, the output row edge is in the middle as shown in FIG. 11B.

Because the element (14, 8) is near the end of the input tensor, on cycles 7-9, the last MACs on the right are getting out-of-bound elements. Similar to the situation illustrated in FIGS. 8A and 8B, all the out-of-bound elements are zero-padded but are different relative to FIGS. 8A and 8B in that the output row edge is at a different position. Further, similar to the situation illustrated in FIGS. 9A-9B, the elements on both sides of the output row edge may be zero-padded. In particular, when an element is either on left or right of the output row edge line, the zero-padding scheme may be identified as zero-padding an element when two adjacent elements of the element are from different rows.

Based on the above example scenarios, the zero padding scheme may be identified based on out-of-bound elements and/or a position of an output row edge. First, all the out-of-bound elements should be zero-padded. Second, when an output row edge is on the leftmost position, zero pad one or more elements next to the output row edge when kernel position is (X, Y), where Y<=floor (kernel_width/2). Third, when an output row edge is on the rightmost position, zero pad one or more elements next to the output row edge when kernel position is (X, Y), where Y>=ceil (kernel_width/2)). Fourth, when an output edge is in the middle, zero pad one or more elements next to the output row edge when kernel position is (X, Y), where Y<=floor (kernel_height/2) or >=ceil(kernel_height/2).

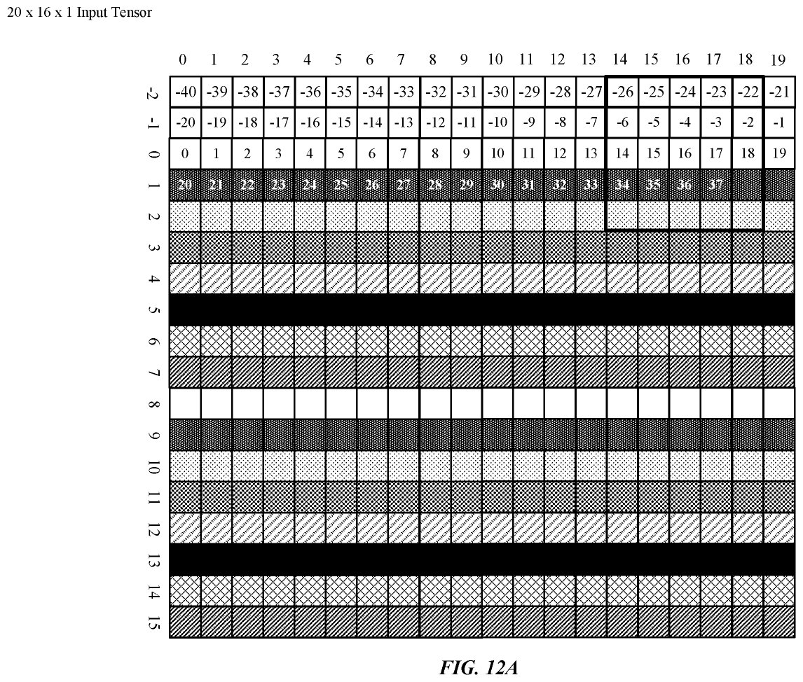

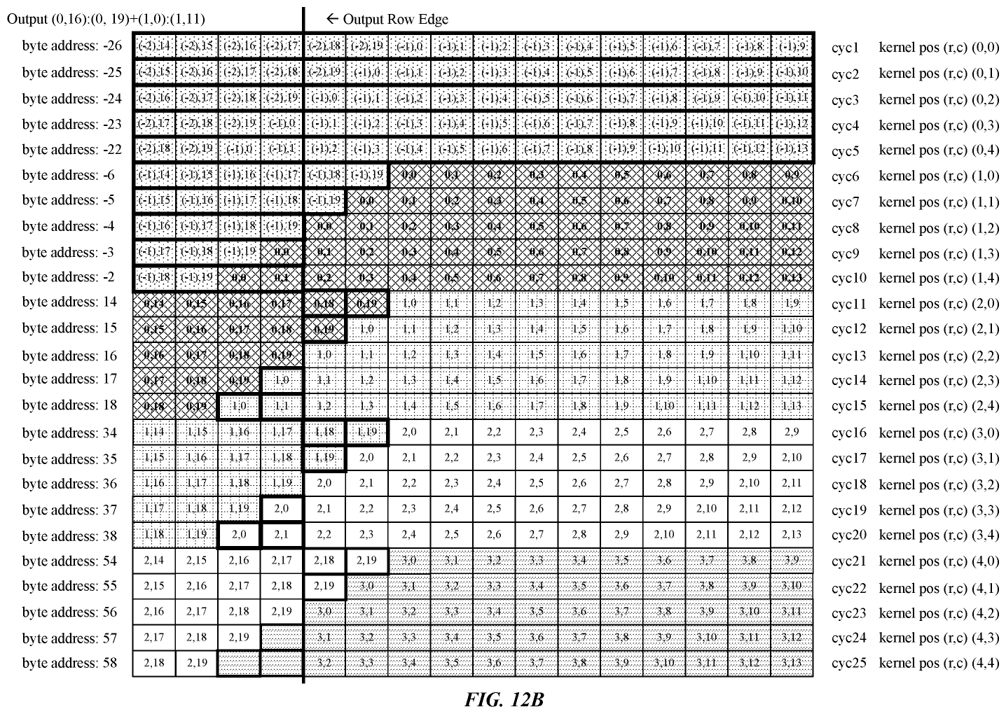

The zero-padding scheme described above may also be implemented in different shaped and/or sized kernels, such as 5×5 kernel. FIGS. 12A and 12B illustrate an example of applying the 5×5 kernel to element (0, 16) of the input tensor 610 to generate element (0, 16) of an output tensor having a same shape and size (16×20×1) as the input tensor 610. Same or similar logic described above is also applicable to this scenario, although the shape or size of a kernel would affect the sizes and/or zero-padding areas. Generally, a greater the kernel size would result in greater zero padding areas.

### Example XOR Gate Implementation

The zero-padding scheme described above with reference to FIGS. 6 through 12B may be implemented via two registers and an XOR gate, such as registers 411 and XOR gate 413 of FIG. 4A. In some embodiments, an XOR gate, and two registers, namely a padded register and an edge register, are implemented for each NE. The padded register is used to record zero padded MACs, and the edge register is used to record an output row edge. FIGS. 13A through 13E illustrate an example embodiment of the edge register and the padded register, corresponding to cycles 11-15 of FIG. 12B.

In some embodiments, the padded register is 16 bits shift register. The bit values indicate whether the corresponding MAC should ignore the coming data or not. In some embodiments, 1 indicates that the corresponding MAC should be ignored. The edge register is also 16 bits. The bit values indicate where the output row edge is, where 1 indicates the output row edge. For example, as illustrated in FIG. 13A, in this scenario, the edge is at index 3 of the edge register. The edge register is set once for each partition of an input tensor. Each input tensor is divided into a plurality of equal-sized partitions (e.g., 16 elements) in a raster scan direction. Each partition may be loaded into and computed by one of the NEs. The padded register needs to be reloaded at beginning of each kernel row. After that, the padded register is shifted every cycle to left using an XOR operation shown in the equation (1) below:

$$Padded ( i ) = Edge ( i ) XOR Padded ( i + 1 ) \qquad ( 1 )$$

After the above XOR operation, the 2 bits of the padded register are set to one, which corresponds to the scenario of cycle 12. FIG. 13B illustrates the values of the padded register and the edge register, corresponding to cycle 12. Again, the XOR operation is performed on the zero-padding pattern of padded register of FIG. 13B to generate a zero-padding pattern for cycle 13, which is illustrated in FIG. 13C; the XOR operation is performed on the zero-padding pattern of the padded register of FIG. 13C to generate a zero-padding pattern for cycle 14, shown in FIG. 13D; and the XOR operation is performed on the zero-padding pattern of padded register of FIG. 13D to generate a zero-padding pattern for cycle 15, shown in FIG. 13E.

Similarly, in cycles 12-15 of FIG. 12B, values loaded in the padded register also follows the above equation (1). However, cycles 6-10 of FIG. 12B are different from cycles 11-15 of FIG. 12B. That is, in cycles 6-10 of FIG. 12B, the first 4 MAC will be working on data that belongs to an out-of-bound row. Thus, they need to be padded at all times, and extra logic is needed to support such a padding pattern. To enable such a padding pattern, an enable signal (denoted as “edge_en”) is added to the edge register.

FIGS. 13F-13H illustrate an example embodiment of the edge register and the shift register, corresponding to cycles 6-10 of FIG. 12B. Referring back to FIG. 12B, in cycle 6, data going into the first 6 MACs should be padded. Thus, the padded register is initialized with six 1s.towards the left side. The edge register is still set to index 3. In a next cycle, the padded region needs to shift to left, which is not possible since the 4th element of padded will become 0 as a result of where edge line is. To address this, edge_en is added to deactivate the impact o the edge register. As such, the logic of the padded register shifting is modified as equation (2) below:

$$Padded ( i ) = ( Edge ( i ) \&\& edge\_en ) XOR Padded ( i + 1 ) \qquad ( 2 )$$

For example, FIG. 13F shows that in cycle 6, edge_en is set to 0, so that the right most 1 in the padded register becomes a 0 in the following cycle and the rest of them stay unchanged. The updated padded register in cycle 7 is shown in FIG. 13G. The updated padded register in cycle 8 is shown in FIG. 13H. Notably, in cycle 8, edge_en is toggled to 1, since the padded region should not change after this. Thus, using the additional signal, edge_en, the extra pattern observed in cycles 6-10 of FIG. 12B is regenerated.

As another example, referring back to FIG. 10B, the output row edge line is all the way to the right. In this case, the controller should treat padded bits similarly as to the situation when edge line is in the middle and also follow the expected pattern of the first cycle of each kernel row.

FIGS. 13I through 13K illustrate an example embodiment of an edge register and a padded register, corresponding to cycles 1-3 of FIG. 10B. FIG. 13I illustrates values of the padded register and the edge register, corresponding to cycle 1 of FIG. 10B. Referring back to FIG. 10B, in cycle 1, no zero-padding is to be performed. The next data that is coming in to be used in a next cycle is element (6, 19), and its corresponding padded bit is set to 1, so that when it passes the edge and enters the padded register, it becomes not-padded or 0. Note that this is the same padding pattern as when the output row edge line was somewhere in the middle. On the other hand, referring to FIG. 13J, the data that comes right after that in cycle 2 (to be used in cycle 3), element (7, 0), should have the corresponding bit set to 0 this time. In this way, when the data passes the edge border, its corresponding bit in the padded register becomes 1 in cycle 3, which is expected since that element belongs to another row, as shown in FIG. 13K. In each of the cycles 1-3 illustrated in FIGS. 13I through 13K, above equation (2) applies.

As another example, referring back to FIG. 11B, partial horizontal padding is needed in the bottom row of the output tensor during cycles 7-9. In this scenario, all the out-of-bound elements (4 elements on the right) should be zero-padded in all cycles. In the second half of the kernel columns, e.g., cycle 9, one element on the left side of the output row edge line should be zero-padded. In this case, an element left of the output row edge line is zero-padded when elements on the right side are still zero-padded. In other words, the XOR logic cannot handle this scenario. Given that the edge register alone is not sufficient to support this case, the edge_en is also used to address this case.

FIGS. 13L through 13N illustrate an example embodiment of an edge register and a padded register, corresponding to cycles 7-9 of FIG. 11B. FIG. 13L illustrates values of the padded register and the edge register, corresponding to cycle 7 of FIG. 11B. As shown in FIG. 13L, all 4 elements on the right side are zero-padded, and edge_en is set to 1. Again, equation (2) is used to perform the XOR operation on the values in the padded register, which will result in the values of cycle 8. FIG. 13M illustrates values of the padded register and the edge register, corresponding to cycle 8, where edge_en is set to 0. Again, equation (2) is used to perform the XOR operation on the values in the padded register, which will result in the values of cycle 9 shown in FIG. 13N. In FIG. 13N, a new 1 has appeared on the left side of the output row edge line, which follows the expected behavior as observed in FIG. 11B.

In some embodiments, to set these signals, NE control 418 tracks the following: (1) output column (denoted as “output_col”) of the first MAC, including output column index corresponding to the first element read from the memory (MAC0), (2) output row (denoted as “output_row”) of the first MAC, including output row index corresponding to the first element read from the memory (MAC0), (3) kernel column (denoted as “kernel_col”), including kernel column index that is currently being read from KMEM (0 being left most column of the kernel), and (4) kernel row (denoted as “kernel_row”), including kernel row index that is currently being read from KMEM (0 being top row of the kernel).

FIG. 14 illustrates logic for initializing the padded register and datain bit corresponding to the data elements passed to NEs in next cycles. To generate an initial pattern for the padded register, the logic may use a 16-bit decoder to generate enough number of ones (starting from leftmost bit), and also a 16-bit shifter to adjust the position of those 1s. Using these two simple blocks, all the patterns observed above can be generated at the first cycle of each kernel row.

### Example Processes for Generating a Zero-Padding Pattern and Performing Zero-Padding Based on the Generated Pattern

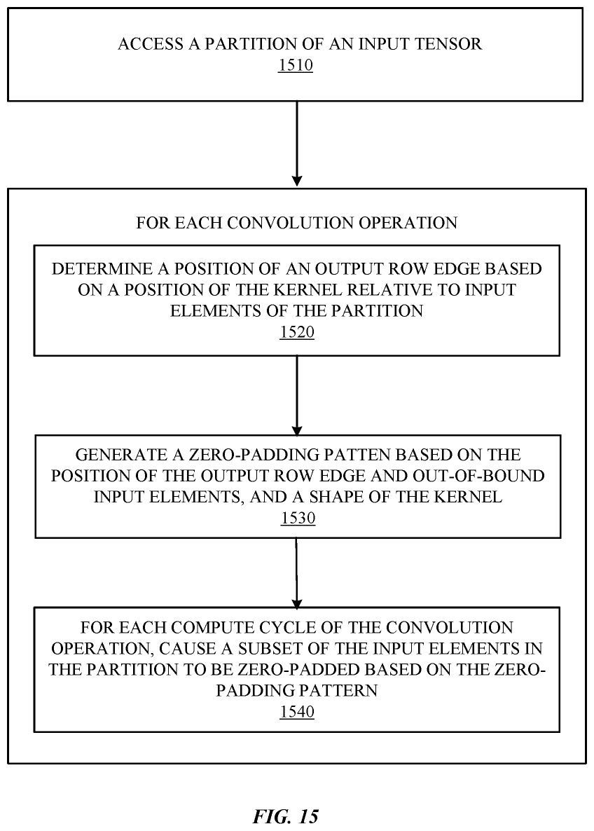

FIG. 15 is a flowchart illustrating a method of compiling operations associated with a neural network, according to one or more embodiments. The method may be performed by a neural processor circuit 218.

The neural processor circuit 218 accesses 1510 a partition of an input tensor having input elements stored in a buffer memory. In some embodiments, the neural processor circuit 218 includes a data processor circuit and a plurality of neural engines. The data processor circuit divides the input tensor into a plurality of partitions, each of which has a predetermined number of input elements. A particular neural engine of the plurality of neural engine is to perform convolution operation on a particular partition of the plurality of partitions to generate a partition of an output tensor having output elements based on a kernel having a predetermined shape.

For each convolution operation, the neural processor circuit 218 determines 1520 a position of an output row edge based on a position and a shape of the kernel. In some embodiments, the data processor circuit determines the position of the output row edge. The neural processor circuit 218 generates 1530 a zero-padding pattern based on the position of the output row edge and out-of-bound input elements. For each compute cycle of the convolution operation, the data processor circuit 318 causes 1540 a subset of the input elements to be zero padded based on the zero-padding pattern.

In some embodiments, each neural engine includes an edge register, a padded register, and an XOR gate. For each partition, the data processor circuit causes the edge register to be loaded based on the position of the output row edge, where 1 indicates that a corresponding input element is the position of the output row edge. For each kernel row, the data processor circuit causes the padded register to be loaded based on the zero-padding pattern, where 1 indicates that a corresponding input element is to be ignored. For a compute cycle in a same kernel row, the neural engine uses the XOR gate to update the padded register based on current values of the first register and the padded register and the zero-padding pattern.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method for efficient zero-padding in convolution, the method comprising:
accessing a partition among a plurality of partitions of an input tensor, wherein the input tensor is divided into the plurality of partitions in a raster-scan direction;
for each row of a kernel for performing convolution on the input tensor:
populating a register with a set of values indicating a zero-padding pattern;
for a compute cycle in the row of the kernel:
performing computations associated with convolution based in part on the zero-padding pattern,
generating an updated zero-padding pattern representing a zero-padding pattern for a next cycle in the row of the kernel, and
updating the set of values in the register with the updated zero-padding pattern.

2. The method of claim 1, wherein generating an updated zero-padding pattern is based in part on out-of-bound input elements or a position of an output row edge.

3. The method of claim 2, further comprising:
for each partition, populating a second register with a second set of values, indicating the position of the output edge row.

4. The method of claim 3, wherein generating the updated zero-padding pattern representing a zero-padding pattern for a next cycle comprises performing an XOR operation between the set of values in the register, and the second set of values in the second register.

5. The method of claim 2, wherein generating the zero-padding pattern comprises:
determining that a kernel row or column is out of bound;
identifying out-of-bound input elements based on the out-of-bound kernel row or column; and
including the out-of-bound input elements in the zero-padding pattern.

6. The method of claim 2, wherein generating the zero-padding pattern comprises:
determining whether an output row edge is at a leftmost position;
responsive to determining that the output row edge is at the leftmost position, for each compute cycle;
determining whether a kernel element positioned at a row corresponding to a row number and a column corresponding to a column number satisfies a condition of that the column number is no greater than a floor of a half of a width of the kernel; and
responsive to determining that the kernel element satisfies the condition, identifying one or more input elements next to the output row edge; and
including the one or more input elements in the zero-padding pattern.

7. The method of claim 2, wherein generating the zero-padding pattern comprises:
determining whether an output row edge is at a rightmost position;
responsive to determining that the output row edge is at the rightmost position, for each compute cycle:
determining whether a kernel element positioned at a row corresponding to a row number and a column corresponding to a column number satisfies a condition of that the column number is no less than a ceiling of a half of a width of the kernel;
responsive to determining that the kernel element satisfies the condition, identifying one or more input elements next to the output row edge and
including the one or more input elements in the zero-padding pattern.

8. The method of claim 2, wherein generating the zero-padding pattern comprises:
responsive to determining that the output row is in a middle position, for each compute cycle,
determining a kernel element positioned at a row corresponding to a row number and a column corresponding to a column number satisfies a condition of that the column number is no greater than a floor of a half of a height of the kernel or no less than a ceiling of a half of a height of the kernel; and
identifying one or more input elements next to the output row edge; and
including the one or more input elements in the zero-padding pattern.

9. The method of claim 1, wherein each value in the set of values corresponds to a compute circuit configured to perform computation associated with the convolution, and performing computations associated with convolution comprises:
keeping a result of a compute circuit corresponding to an active value in the set of values; and
ignoring a result of a compute circuit corresponding to an inactive value in the set of values.

10. A non-transitory storage medium storing instruction thereon, the instructions when executed by a processor cause the processor to:
access a partition among a plurality of partitions of an input tensor, wherein the input tensor is divided into the plurality of partitions in a raster-scan direction;
for each row of a kernel for performing convolution on the input tensor:
populate a register with a set of values indicating a zero-padding pattern;
for a compute cycle in the row of the kernel:
perform computations associated with convolution based in part on the zero-padding pattern,
generate an updated zero-padding pattern representing a zero-padding pattern for a next cycle in the row of the kernel, and
update the set of values in the register with the updated zero-padding pattern.

11. The non-transitory storage medium of claim 10, wherein generating an updated zero-padding pattern is based in part on out-of-bound input elements or a position of an output row edge.

12. The non-transitory storage medium of claim 11, further comprising:
for each partition, populating a second register with a second set of values, indicating the position of the output edge row.

13. The non-transitory storage medium of claim 12, wherein generating the updated zero-padding pattern representing a zero-padding pattern for a next cycle comprises performing an XOR operation between the set of values in the register, and the second set of values in the second register.

14. The non-transitory storage medium of claim 11, wherein generating the zero-padding pattern comprises:
determining that a kernel row or column is out of bound;
identifying out-of-bound input elements based on the out-of-bound kernel row or column; and
including the out-of-bound input elements in the zero-padding pattern.

15. A neural processor circuit, comprising:
a data processor circuit having a buffer memory storing an input tensor; and
a plurality of neural engines;
wherein the data processor circuit is configured to:
accessing a partition among a plurality of partitions of an input tensor, wherein the input tensor is divided into the plurality of partitions in a raster-scan direction;
for each row of a kernel for performing convolution on the input tensor:
populating a register with a set of values indicating a zero-padding pattern;
for a compute cycle in the row of the kernel:
performing computations associated with convolution based in part on the zero-padding pattern,
generating an updated zero-padding pattern representing a zero-padding pattern for a next cycle in the row of the kernel, and
updating the set of values in the register with the updated zero-padding pattern.

16. The neural processor circuit of claim 15, wherein generating an updated zero-padding pattern is based in part on out-of-bound input elements or a position of an output row edge.

17. The neural processor circuit of claim 16, further comprising:
for each partition, populating a second register with a second set of values, indicating the position of the output edge row.

18. The neural processor circuit of claim 17, wherein generating the updated zero-padding pattern representing a zero-padding pattern for a next cycle comprises performing an XOR operation between the set of values in the register, and the second set of values in the second register.

19. The neural processor circuit of claim 16, wherein generating the zero-padding pattern comprises:
determining that a kernel row or column is out of bound;
identifying out-of-bound input elements based on the out-of-bound kernel row or column; and
including the out-of-bound input elements in the zero-padding pattern.

20. The neural processor circuit of claim 16, comprising a plurality of compute circuits configured to perform computation associated with the convolution, wherein each value in the set of values corresponds to one of the plurality of compute circuits, and performing computations associated with convolution comprises:
keeping a result of a compute circuit corresponding to an active value in the set of values; and
ignoring a result of a compute circuit corresponding to an inactive value in the set of values.
